(19) United States
(12) Patent Application Publication
(10) Pub. No.: US 2021/0230506 A1
(43) Pub. Date: Jul. 29, 2021

(54) DECORATIVE WAX ELEMENT AND A METHOD OF DECORATING A CANDLE USING A DECORATIVE WAX ELEMENT

(71) Applicant: M G Marklin, LLC, Contoocook, NH (US)

(72) Inventor: Martin Marklin, Contoocook, NH (US)

(73) Assignee: M G Marklin, LLC, Contoocook, NH (US)

(21) Appl. No.: 17/154,511

(22) Filed: Jan. 21, 2021

Related U.S. Application Data
(60) Provisional application No. 62/964,799, filed on Jan. 23, 2020.

(51) Int. Cl. C11C 5/00; B44C 1/10; B44C 1/18

(52) U.S. Cl. CPC C11C 5/008; B44C 1/18; B44C 1/10

(57) ABSTRACT

A decorative wax element used in decorating a candle as well as a method of decorating a wax candle utilizing a wax element on which has been or is applied or splattered melted colored wax in a random pattern. An undecorated wax piece is prepared either on or off the candle to be decorated. Colored molten wax is then splattered on the surface of the undecorated wax piece in a random pattern. The randomly decorated wax element may be prepared either remote from the candle and subsequently applied to the surface or indentation in the surface of the candle or alternatively, the random pattern may be applied to an undecorated wax element previously applied to the candle.

This application claims priority from U.S. Provisional Patent Application No. 62/964,799 entitled “DECORATIVE WAX ELEMENT AND A METHOD OF DECORATING A CANDLE USING A DECORATIVE WAX ELEMENT”, filed on Jan. 23, 2020 which is incorporated fully herein by reference.

### TECHNICAL FIELD

The invention relates in general to a wax element used in decorating a candle and in particular, to such a wax element as well as a method of decorating a wax candle utilizing a wax object of almost any shape created by melted wax and which is subsequently applied to the surface of a candle or inlayed into a groove in the candle surface and on which is applied or splattered (wither previously or in situ) melted colored wax in a random pattern.

### BACKGROUND INFORMATION

Wax candles such as those utilized in liturgical settings typically include ornamentation; which ornamentation is often geared toward specific liturgical events or celebrations. Such ornamentation often includes brushed on wax; painted on images or patterns, or even three-dimensional objects pressed into the wax surface.

Accordingly, what is presented herein and claimed is a new unique method for providing a decorative element such as a band, rectangle, circle, square, cross, star or some other element on a wax candle or other similar item.

### SUMMARY OF THE INVENTION

The present invention features a decorative wax element for the surface of a candle. The decorative wax element comprises a generally flat piece of wax material having a top surface and a bottom surface, wherein the top surface includes one of either a smooth surface or a textured surface, and wherein the top surface of the generally flat piece of wax material includes a randomly applied colored pattern.

In one embodiment, the randomly applied colored pattern is a colored wax pattern which may be selected from the colors including gold, silver and bronze. The randomly applied colored wax pattern may be a splattered molten wax pattern randomly applied to the top surface of the generally flat piece of wax material. The decorative wax element may be shaped as any geometric shape including, but not limited to a square, a circle, a rectangle, a rectangular band encircling a circumference of the candle, a cross, a star or any other shape.

The invention also includes a method of decorating the surface of a candle or other object utilizing a decorative wax element on which is applied a random pattern of molten wax. The method comprises the acts of providing a generally flat piece of wax material having a top surface and a bottom surface.

The method next includes the act of randomly applying molten colored wax to the top surface of the generally flat piece of wax material to form a decorative wax element for the surface of an object and subsequently applying the decorative wax element to the surface of an object.

The method may include the act of randomly applying molten colored wax to the top surface of the generally flat piece of wax material with the generally flat piece of wax material remote from the object following which the decorative wax element is applied to the surface of a candle. The decorative wax element may be applied to the surface of an object, like a candle or to a groove or recess in the surface of an object like a candle.

The act of randomly applying molten colored wax to the top surface of the generally flat piece of wax material may be performed before or after the generally flat piece of wax material has been applied to the surface of an object. In another embodiment, the method may further include the act of applying colored decorative wax or colored decorative paint to edges of the decorative wax element after the decorative wax element has been applied to the surface of an object, such as but not limited to a candle.

The generally flat piece of wax material may be shaped as one or more of a square, a circle, a rectangle, a rectangular band, a cross, a star or any other goemetric shape or object. The rectangular band may encircle the circumference of a candle.

### BRIEF DESCRIPTION OF THE DRAWINGS

These and other features and advantages of the present invention will be better understood by reading the following detailed description, taken together with the drawings wherein:

FIG. 1 is a diagram of a decorative wax element prepared prior to its application to a candle according to one embodiment of the present invention;

FIG. 2 is a diagram of a wax element including randomly applied splattered pattern in accordance with one feature of the present invention;

FIG. 3 is a close-up diagram illustrating the wax element with randomly applied splattered pattern on a candle including edge gilding applied in accordance with another embodiment of the present invention to create a decorative wax element; and

FIG. 4 is a close-up diagram illustrating various shaped wax appliques in accordance to the teaching of the present invention.

### DETAILED DESCRIPTION OF THE PREFERRED EMBODIMENTS

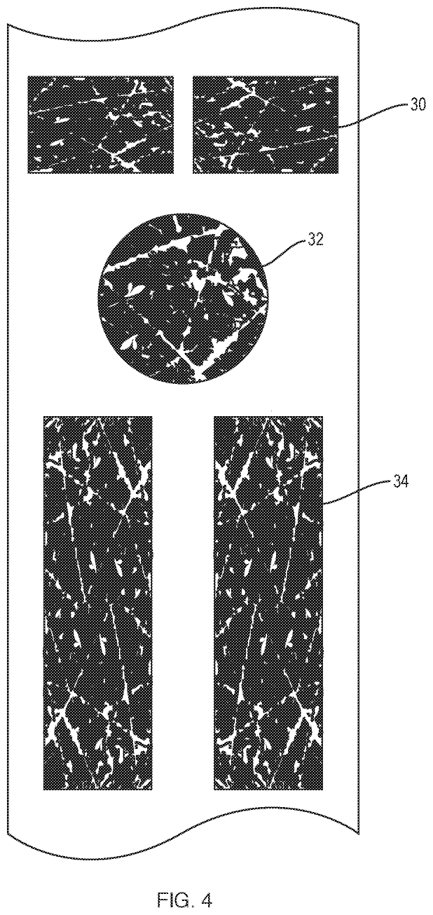

The present invention features a method of decorating a candle utilizing a decorative wax element. Although the present invention will be explained primarily in connection with a wax “band” as shown in FIGS. 1-3, the present invention is not limited to a “band” but also contemplates other decorative shapes and objects such as squares 30, FIG. 4, circles 32, rectangular shapes 34 or any other geometric shape or object such as a cross, star or the like. Any and all other geometric shapes are contemplated by the present invention and considered within the scope of the claims of the invention.

According to one embodiment of the present invention, a decorative wax element 10, FIG. 1, is prepared independently from the candle which is to be decorated. The decorative wax element 10 can be formed, according to one embodiment, by first preparing a non-decorated wax element 12 which may be made by pouring molten wax into a mold or other process well known to those skilled in the art. This generates an element 12 having a top surface which may be smooth and shiny or textured, all according to the desires of the user.

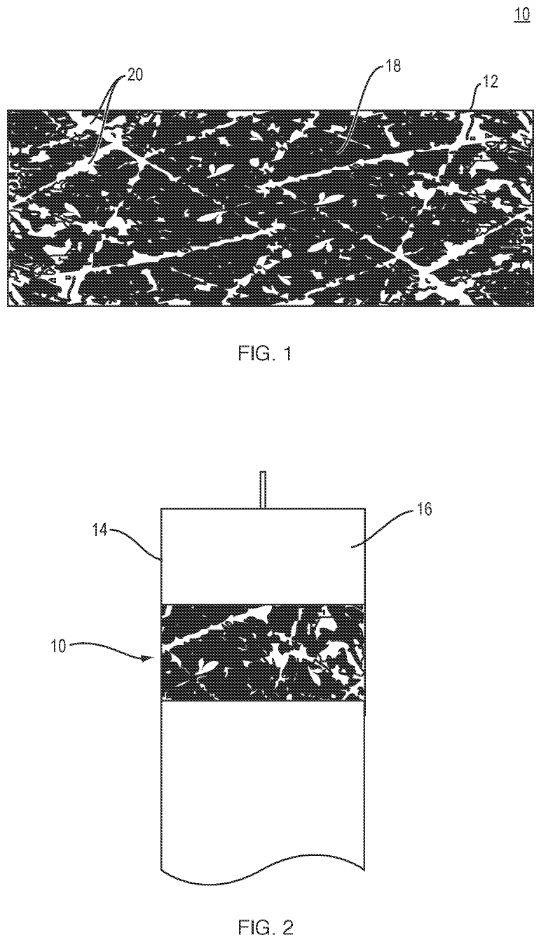

In one embodiment, the non-decorated wax element can be applied directly to the surface of a candle 14, FIG. 2, by using molten wax as an adhesive, by actually melting wax into a groove in the surface of a wax candle, or by other means desired. In another embodiment, a non-decorated or decorated element 10 may be applied to a recess carved into the surface 16 of the candle 14. In either or both of these embodiments, the element applied to the wax candle 14 may either be undecorated, wherein the decorating is performed once the element is applied to the candle 14, or alternatively, the element may be pre-decorated and applied as a decorated element to the surface of the candle 14.

In either method, after an undecorated wax element 12 is prepared (either remote from the candle or in-situ on the candle itself) a random pattern is applied by splattering colored molten wax 20 onto the surface 18 of the undecorated element 12. The colored molten wax is preferably gold, silver or bronze colored wax although other colors are contemplated and within the scope of the present invention. Alternatively, the random pattern may be of paint or some other element other than molten wax.

The application of the colored, molten wax may be applied by hand using a device such as a paint brush, for example, dipped into molten wax and then splattered onto the undecorated element 12. Alternatively, a random pattern may be applied using mechanical means or a device other than a paint brush.

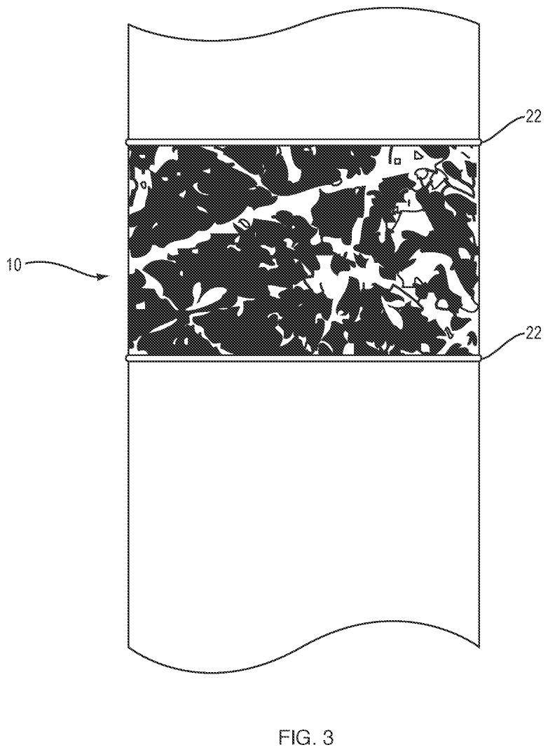

Once the decorated element 10, FIG. 3 is applied to the candle, in one embodiment gold gilding 22 may be applied to the edges of the element 10 to accentuate or “finish” the edge of the decorated wax element 10.

Accordingly, the present invention features a randomly decorated colored wax element for application as a decorative element on a wax candle or applied directly into a groove of the candle. The present invention also features a method of manufacturing such a decorated colored wax element having a random splattered wax pattern.

Modifications and substitutions by one of ordinary skill in the art are considered to be within the scope of the present invention, which is not to be limited except by the allowed claims and their legal equivalents.

What is claimed is:

1. A decorative wax element for the surface of a candle, the decorative wax element comprising:
a generally flat piece of wax material, said generally flat piece sheet of wax material having a top surface and a bottom surface, wherein said top surface includes one of either a smooth surface or a textured surface, and wherein said top surface of said generally flat piece of wax material includes a randomly applied colored pattern.

2. The decorative wax element according to claim 1, wherein said randomly applied colored pattern is a colored wax pattern.

3. The decorative wax element according to claim 2, wherein said colored wax pattern is selected from the colors including gold, silver and bronze.

4. The decorative wax element according to claim 2, wherein said randomly applied colored wax pattern is a splattered molten wax pattern randomly applied to said top surface of said generally flat piece of wax material.

5. The decorative wax element according to claim 1, wherein said generally flat piece of wax material is shaped as one or more of a geometric shape or other object shape.

6. The decorative wax element according to claim 5, wherein said geometric shape includes one or more of a square, a circle, a rectangle, a rectangular band encircling a circumference of said candle, a cross and a star.

7. A method of decorating the surface of an object utilizing a decorative wax element on which is applied a random pattern of molten wax, said method comprising the acts of:
providing a generally flat piece of wax material, said generally flat piece of wax material having a top surface and a bottom surface;
randomly applying molten colored wax to said top surface of said generally flat piece of wax material to form a decorative wax element for the surface of an object; and
applying said decorative wax element to the surface of an object.

8. The method of claim 7, wherein said act of randomly applying molten colored wax to said top surface of said generally flat piece of wax material is performed with said generally flat piece of wax material remote from said object, and further including the act of applying the decorative wax element to the surface of a candle.

9. The method of claim 8, wherein said decorative wax element is applied to a recess in the surface of said candle.

10. The method of claim 7, wherein said act of randomly applying molten colored wax to said top surface of said generally flat piece of wax material is performed after said generally flat piece of wax material has been applied to the surface of said object.

11. The method of claim 8, further including the act of applying colored decorative wax or colored decorative paint to edges of said decorative wax element after said decorative wax element has been applied to said candle.

12. The method of claim 10, further including the act of applying colored decorative wax or colored decorative paint to edges of said decorative wax element after said generally flat piece of wax material has been applied to the surface of said object.

13. The method of claim 7, wherein said generally flat piece of wax material is shaped as one or more of a geometric shape or other object shape.

14. The method of claim 13, wherein said geometric shape includes one or more of a square, a circle, a rectangle, a rectangular band encircling a circumference of said candle, a cross and a star.
